(19) United States
(12) Patent Application Publication
(10) Pub. No.: US 2009/0128534 A1
(43) Pub. Date: May 21, 2009

(54) ACTIVE MATRIX DISPLAY DEVICES

(75) Inventors: David A. Fish, Haywards Heath (GB); Steven C. Deane, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,817

(22) PCT Filed: Oct. 24, 2005
(86) PCT No.: PCT/IB05/53479

§ 371 Date: Apr. 24, 2007

(30) Foreign Application Priority Data
Oct. 29, 2004 (GB) 0424112.1

(51) Int. Cl. G09G 5/00; G09G 3/32

(52) U.S. Cl. 345/211; 345/82

(57) ABSTRACT

A method of driving an active matrix display device comprises, for each pixel, driving a current through a drive transistor (22) by applying a gate voltage to the drive transistor which comprises a fixed component and a component which depends on a measurement of the threshold voltage of the drive transistor (22), and switching off the drive transistor using a discharge transistor (36) for discharging a capacitance between the gate and source of the drive transistor (22), and at a time which depends on the optical output of the display element (2) and a pixel data signal. This method uses optical feedback to implement a duty cycle control for the output of the display element. The brightness of the display element when turned on is determined by the drive transistor drive voltage, and this takes account of the threshold voltage. Although the optical feedback system enables compensation of the threshold voltage, by providing compensation initially in this way, the lifetime for correct functioning of the optical feedback system can be extended. The time at which the drive transistor is switched off can also depend on a measured threshold voltage of the discharge transistor.

This invention relates to active matrix display devices, particularly but not exclusively active matrix electroluminescent display devices having thin film switching transistors associated with each pixel.

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments in organic electroluminescent materials, particularly polymer materials, have demonstrated their ability to be used practically for video display devices. These materials typically comprise one or more layers of a semiconducting conjugated polymer sandwiched between a pair of electrodes, one of which is transparent and the other of which is of a material suitable for injecting holes or electrons into the polymer layer.

The polymer material can be fabricated using a CVD process, or simply by a spin coating technique using a solution of a soluble conjugated polymer. Ink-jet printing may also be used. Organic electroluminescent materials can be arranged to exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-addressed display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

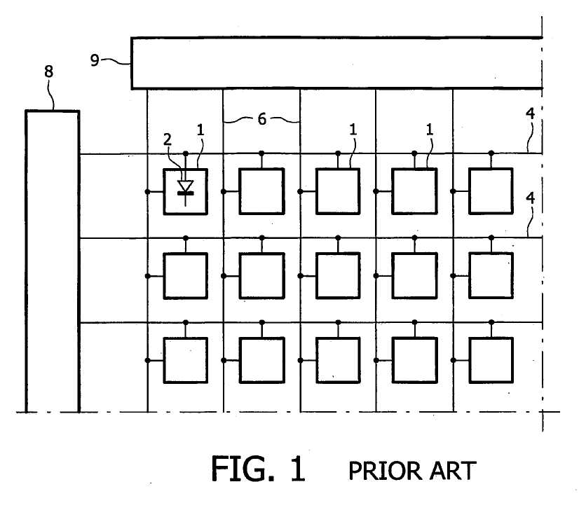

FIG. 1 shows a known active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support.

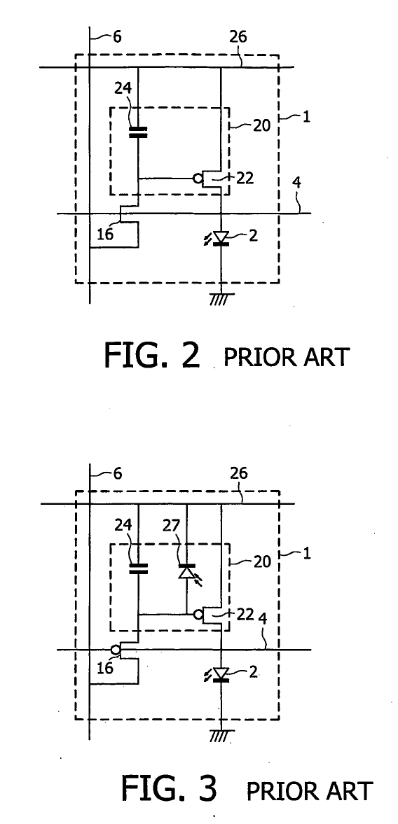

FIG. 2 shows in simplified schematic form a first known pixel and drive circuitry arrangement for providing voltage-addressed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

The drive transistor 22 in this circuit is implemented as a p-type TFT, so that the storage capacitor 24 holds the gate-source voltage fixed. This results in a fixed source-drain current through the transistor, which therefore provides the desired current source operation of the pixel.

In the above basic pixel circuit, for circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

It has been recognised that a current-addressed pixel (rather than a voltage-addressed pixel) can reduce or eliminate the effect of transistor variations across the substrate. For example, a current-addressed pixel can use a current mirror to sample the gate-source voltage on a sampling transistor through which the desired pixel drive current is driven. The sampled gate-source voltage is used to address the drive transistor. This partly mitigates the problem of uniformity of devices, as the sampling transistor and drive transistor are adjacent each other over the substrate and can be more accurately matched to each other. Another current sampling circuit uses the same transistor for the sampling and driving, so that no transistor matching is required, although additional transistors and address lines are required.

There have also been proposals for voltage-addressed pixel circuits which compensate for the aging of the LED material. For example, various pixel circuits have been proposed in which the pixels include a light sensing element. This element is responsive to the light output of the display element and acts to leak stored charge on the storage capacitor in response to the light output, so as to control the integrated light output of the display during the address period. FIG. 3 shows one example of pixel layout for this purpose. Examples of this type of pixel configuration are described in detail in WO 01/20591 and EP 1 096 466.

In the pixel circuit of FIG. 3, a photodiode 27 discharges the gate voltage stored on the capacitor 24. The EL display element 2 will no longer emit when the gate voltage on the drive transistor 22 reaches the threshold voltage, and the storage capacitor 24 will then stop discharging. The rate at which charge is leaked from the photodiode 27 is a function of the display element output, so that the photodiode 27 functions as a light-sensitive feedback device. It can be shown that the integrated light output, taking into the account the effect of the photodiode 27, is given by:

. . . [1]

In this equation, η_{PD} is the efficiency of the photodiode, which is very uniform across the display, Cs is the storage capacitance, V(0) is the initial gate-source voltage of the drive transistor and V_{T} is the threshold voltage of the drive transistor. The light output is therefore independent of the EL display element efficiency and thereby provides aging compensation. However, V_{T} varies across the display so it will exhibit non-uniformity.

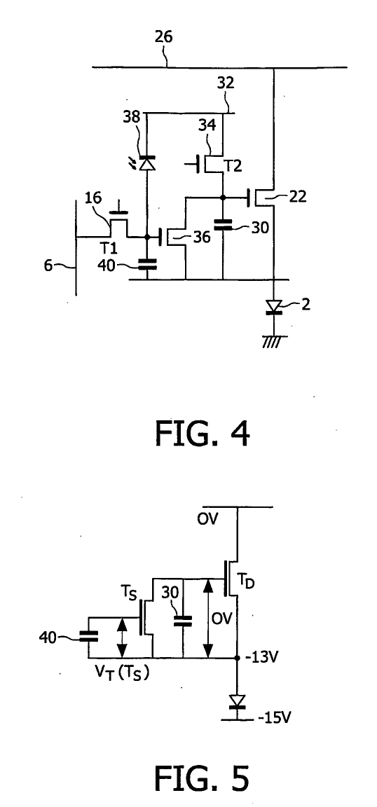

In order to additionally compensate for the stress induced threshold voltage variations of an amorphous silicon drive transistor, and to avoid the gradual drop of in drive current in this circuit, the circuit of FIG. 4 has been proposed by the applicant.

FIG. 4 shows an example of this proposed pixel layout, and shown for implementation using amorphous silicon n-type transistors.

The gate-source voltage for the drive transistor 22 is again held on a storage capacitor 30. However, this capacitor is charged to a fixed voltage from a charging line 32, by means of a charging transistor 34 (T2). Thus, the drive transistor 22 is driven to a constant level which is independent of the data input to the pixel when the display element is to be illuminated. The brightness is controlled by varying the duty cycle, in particular by varying the time when the drive transistor is turned off.

The drive transistor 22 is turned off by means of a discharge transistor 36 which discharges the storage capacitor 30. When the discharge transistor 36 is turned on, the capacitor 30 is rapidly discharged and the drive transistor turned off.

The discharge transistor is turned on when the gate voltage reaches a sufficient voltage. A photodiode 38 is illuminated by the display element 2 and generates a photocurrent in dependence on the light output of the display element 2. This photocurrent charges a discharge capacitor 40, and at a certain point in time, the voltage across the capacitor 40 will reach the threshold voltage of the discharge transistor 40 and thereby switch it on. This time will depend on the charge originally stored on the capacitor 40 and on the photocurrent, which in turn depends on the light output of the display element.

Thus, the data signal provided to the pixel on the data line 6 is supplied by the address transistor 16 (T1) and is stored on the discharge capacitor 40. A low brightness is represented by a high data signal (so that only a small amount of additional charge is needed for the transistor 36 to switch off) and a high brightness is represented by a low data signal (so that a large amount of additional charge is needed for the transistor 36 to switch off).

This circuit thus has optical feedback for compensating ageing of the display element, and also has threshold compensation of the drive transistor 22, because variations in the drive transistor characteristics will also result in differences in the display element output, which are again compensated by the optical feedback. For the transistor 36, the gate voltage over threshold is kept very small, so that the threshold voltage variation is much less significant.

This circuit and the associated timing is explained in greater detail in WO 2004/084168. Modifications to the circuit are also shown in this publication.

The circuit compensates for the drift in threshold voltage of the drive transistor and the ageing of the OLED, but any drift in the threshold voltage of the snap-off transistor 36 can still influence the display output and/or the time over which the feedback compensation remains functional.

According to the invention, there is provided a method of driving an active matrix display device comprising an array of display pixels each comprising a drive transistor and a current-driven light emitting display element, the method comprising, for each addressing of the pixel:

measuring a threshold voltage of a drive transistor;

adding a drive voltage to the drive transistor threshold voltage to derive a compensated drive voltage and storing this on a storage capacitor;

driving the drive transistor using the compensated drive voltage;

switching on a discharge transistor using charge flow through a light dependent device illuminated by the light output of the display element and in dependence on a pixel voltage supplied to the pixel; and

discharging the storage capacitor using the discharge transistor at a time dependent on the pixel voltage and the light output, thereby to turn off the drive transistor.

The discharge transistor performs the snap-off function mentioned above.

This method uses optical feedback to implement a duty cycle control for the output of the display element. The brightness of the display element when turned on is determined by the drive transistor drive voltage, and this takes account of the threshold voltage. Although the optical feedback system enables compensation of the threshold voltage, by providing compensation initially in this way, the lifetime for correct functioning of the optical feedback system can be extended.

The light-dependent device may control the timing of the operation of the discharge transistor by varying the gate voltage applied to the discharge transistor in dependence on the light output of the display element. The light-dependent device can control the timing of the switching of the discharge transistor from an off to an on state.

The method may further comprise measuring a threshold voltage of the discharge transistor, and adding the pixel voltage to the discharge transistor threshold voltage to derive a compensated pixel voltage, the storage capacitor being discharged at a time dependent on the compensated pixel voltage.

According to a second aspect of the invention, there is provided a method of driving an active matrix display device comprising an array of display pixels each comprising a drive transistor and a current-driven light emitting display element, the method comprising, for each addressing of the pixel:

driving a current through the drive transistor by applying a gate voltage to the drive transistor which comprises a fixed component and a component which depends on a measurement of the threshold voltage of the drive transistor; and

switching off the drive transistor using a discharge transistor for discharging a capacitance between the gate and source of the drive transistor, and at a time which depends on the optical output of the display element and a pixel data signal.

This method may be particularly appropriate for amorphous silicon implementations.

The time at which the drive transistor is switched off may also depend on a measured threshold voltage of the discharge transistor.

According to a third aspect of the invention, there is provided a method of driving an active matrix display device comprising an array of display pixels each comprising a drive transistor and a current-driven light emitting display element, the method comprising, for each addressing of the pixel:

driving a current through the drive transistor by applying a gate voltage to the drive transistor which comprises a fixed voltage; and

switching off the drive transistor using a discharge transistor for discharging a capacitance between the gate and source of the drive transistor, and at a time which depends on the optical output of the display element, a pixel data signal and a measured threshold voltage of the discharge transistor.

This method may be particularly appropriate for polysilicon implementations.

The invention also provides an active matrix display device comprising an array of display pixels, each pixel comprising:

a current-driven light emitting display element;

a low temperature polysilicon drive transistor for driving a current through the display element;

a storage capacitor for storing a voltage to be used for addressing the drive transistor;

a discharge transistor for discharging the storage capacitor thereby to switch off the drive transistor; and

a light-dependent device for controlling the timing of the operation of the discharge transistor by varying the gate voltage applied to the discharge transistor in dependence on the light output of the display element,

wherein the device further comprises means for implementing a threshold voltage measurement of the discharge transistor and wherein each pixel further comprises an isolating transistor connected between a power supply line and the drive transistor for switching off the drive transistor during a threshold voltage measurement of the discharge transistor.

This circuit enables accurate measurement of the discharge transistor threshold voltage by ensuring the drive transistor does not corrupt the measurement.

The invention will now be described by way of example with reference to the accompanying drawings, in which:

FIG. 1 shows a known EL display device;

FIG. 2 is a simplified schematic diagram of a known pixel circuit for current-addressing the EL display pixel;

FIG. 3 shows a known pixel design which compensates for differential aging;

FIG. 4 shows an improved known pixel circuit and which is used to explain examples of the method of the invention;

FIGS. 5, 6(a), 6(b), 7 and 8 show different operative states of the circuit of FIG. 4 when used to implement the method of the invention;

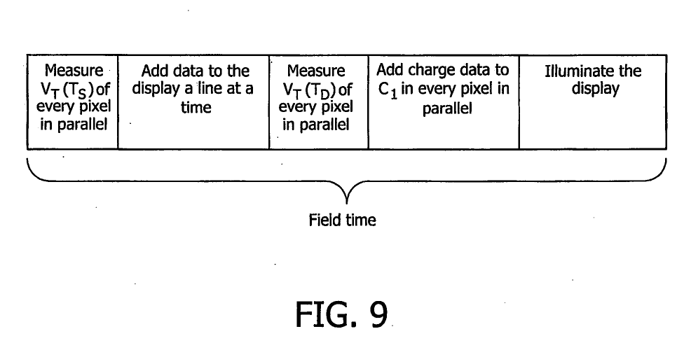

FIG. 9 summarises the steps of the method of the invention;

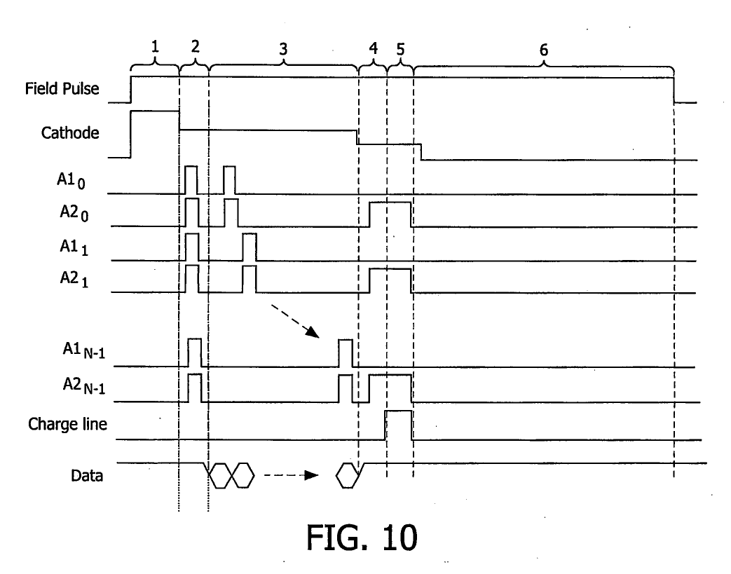

FIG. 10 shows a detailed timing diagram of one example of method of the invention;

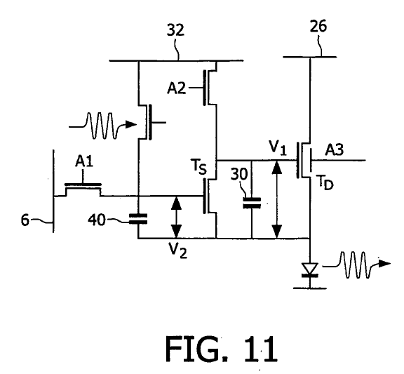

FIG. 11 shows a first circuit modification;

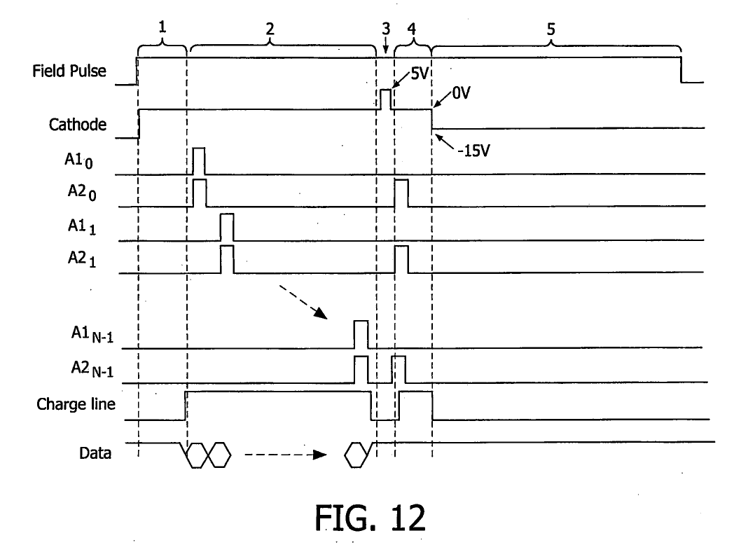

FIG. 12 shows a first modification to the method explained with reference to FIGS. 5 to 10;

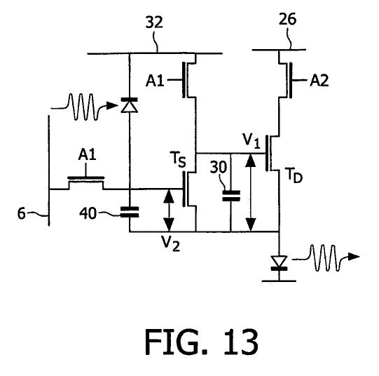

FIG. 13 shows a second circuit modification; and

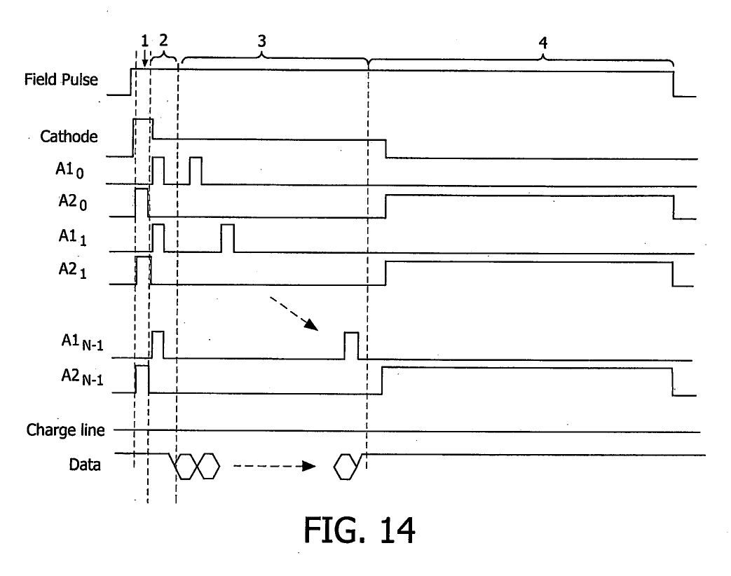

FIG. 14 shows a second modification to the method explained with reference to FIGS. 5 to 10.

It should be noted that these figures are diagrammatic and not drawn to scale. Relative dimensions and proportions of parts of these figures have been shown exaggerated or reduced in size, for the sake of clarity and convenience in the drawings.

FIG. 4 shows one of the known pixel circuits described in the applicants co-pending WO 2004/084168, and this example of pixel circuit is used to explain the invention, which provides a specific operation method to compensate for any threshold voltage drift in the snap off transistor or to extend the correct operation of the display by compensating for the drive transistor threshold variations both using optical feedback and drive voltage compensation.

In FIG. 4, the cathode is shown at ground potential. In practice, and as is shown in the examples below, the cathode potential may be negative, and the power supply line may be at 0V.

In accordance with the invention, an optical feedback pixel drive scheme is provided, using a duty cycle control approach. In embodiment. the drive conditions for the drive transistor take account of a measurement of the threshold voltage of the drive transistor, even though this threshold voltage is compensated by the feedback system. In another embodiment, the drive conditions for a discharge transistor (which controls the duty cycle) takes into account a measured threshold voltage of the discharge transistor. These two approaches may be combined into a single drive scheme.

The driving method of the invention can be implemented for known circuits, but with different timing control.

The driving method assumes that V_{T}(T_{D}) (the threshold voltage of the drive transistor 22, hereinafter also referred to as T_{D}) is always greater than or equal to V_{T}(T_{S}) (the threshold of the snap-off/discharge transistor 36 hereinafter also referred to as T_{S}). This is a valid assumption because T_{D} will have a high over-threshold voltage for a substantial fraction of its life whereas T_{S} will always be at or below its threshold so will have a small amount of threshold voltage drift. There may even be the possibility of negative drift as T_{S} is reversed biased for long periods. Therefore at time zero, the threshold voltages will be equal and thereafter V_{T}(T_{D})>V_{T}(T_{S}).

To describe the drive scheme it is assumed that the circuit is in the following initial state: capacitor 30 is discharged and T_{S} at its threshold voltage V_{T}(T_{S}) and capacitor 40 is holding voltage V_{T}(T_{S}). If necessary this state can easily be obtained by driving the circuit to this mode.

FIG. 5 shows the effective circuit for this state, with some example voltages that will be useful for the explanation of the drive method.

The following steps now describe in detail one example of drive scheme, which combines the threshold measurement of the drive transistor and the snap-off transistor.

### Step 1—Invert the Circuit Polarity

The first step involves providing voltage levels so that the drive transistor is operated in the opposite sense to the normal circuit operation. The purpose of this is to enable the threshold voltages of both the snap-off transistor and the drive transistor to be sampled, as will become apparent further below. This also ensures that the OLED display element is reverse biased and therefore off during the various sampling operations explained below.

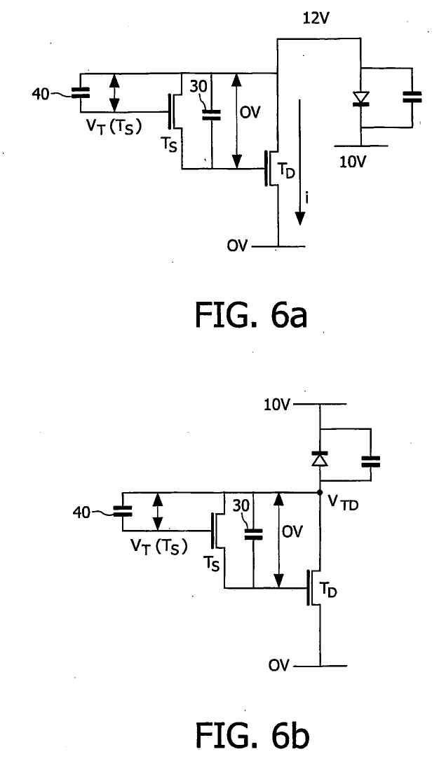

The cathode is initially driven to a high voltage, for example 10V. The effective circuit is shown in FIG. 6(a). As the anode is a high impedance is node it cannot discharge and therefore ends up at a potential of around 12V.

The drive transistor T_{D} is biased in the opposite sense to the sense in which the transistor is biased for the normal pixel operation. The zero volts on capacitor 30 thus defines the gate-drain rather than the gate-source voltage. Therefore there is a large gate-source voltage and the drive transistor T_{D} conducts which brings the anode down to around the threshold voltage of T_{D}, as shown in FIG. 6b. At these high potentials, the switches 16,36 in FIG. 4 are off i.e. their gates are at low potentials.

This means that no gate voltage has to rise above the +12V in FIG. 6a. The maximum gate voltage will only rise a few volts above 0V. Therefore reasonable gate voltage swings can be used for example 25V.

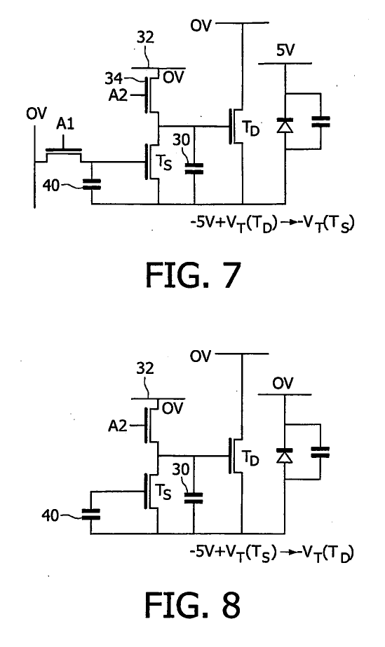

The cathode is then driven down to a low voltage e.g. 5V. The equivalent circuit is shown in FIG. 7.

This 5V drop in the cathode voltage is capacitively coupled, by the OLED capacitance, to the anode. The anode is thus driven low, as it is again a high impedance node, down to a voltage of −5V+V_{T}(T_{D}), as shown in FIG. 7.

This step places the circuit in a condition which enables the threshold voltages to be sampled.

### Step 2—Sample the Threshold Voltage of the Snap-Off Transistor

The address lines A1 and A2 for the address transistor 16 and the charging transistor 34 then go high (for every display row). This has the effect of connecting the two capacitors 30,40 to 0V through the charge line 32 and data lines 6. A voltage of 0V is provided to the charge line 32 and the data line for this purpose.

As the capacitance of the OLED is very high compared to the capacitances 30 and 40, these capacitances are initially charged to 5V −V_{T}(T_{D}).

The charging of the capacitors 30,40 turns on the drive transistor T_{D} and the snap-off transistor T_{S}. As V_{T}(T_{D})≧V_{T}(T_{S}) (as mentioned above) the snap-off transistor T_{S} stops conducting after the drive transistor T_{D}, and the anode charges up to −V_{T}(T_{S}) with voltage V_{T}(T_{S}) stored on the capacitor 40.

The address lines A1 and A2 are then brought low to turn-off the switches 16,34. In practice, the drive transistor T_{D} will be approximately 10 times wider than the snap-off transistor T_{S}, and will therefore leak more as the thresholds of both devices are reached.

The aim is for the snap-off transistor T_{S} to conduct more than T_{D} in all cases so that an accurate measurement is taken of the snap-off transistor threshold voltage.

This can be achieved by additionally holding the data line 6 higher than 0V e.g. 2 or 3V whilst the charge line 32 is still at 0V.

The measurement of V_{T}(T_{S}) will be accurate and the anode will remain at this voltage (ready for data addition) because the leakage currents through T_{S} and T_{D} will be very small. In particular, as the address line A2 for the charging transistor goes low to switch off transistor 34, the drain-source voltage of T_{S} will go to zero, as the capacitor 30 is discharged by the snap-off transistor T_{S}. At the end of this step of measuring the snap-off transistor threshold voltage, the gate-source voltage of the of drive transistor T_{D} is zero, which gives low leakage.

### Step 3—Provide the Pixel Data Voltage on the Capacitor 40

The pixel data is then added to capacitor 40, each line in turn, by bringing high the relevant address line A1. During this time, it does not matter if address line A2 is high or low.

The data applied to the column 6 is either zero volts for a black state pixel or a potential less than zero for an on-state pixel.

With reference to FIG. 7, as the data column 6 is moved through its data voltage swing, namely from 0V to −V_{DATA}, the resulting voltage upon the capacitor 40 (assuming address line A2 is high and thereby couples one terminal of the capacitor 30 to 0V) by:

$${V}_{2} = {V}_{T} ( {T}_{S} ) - \frac{{C}_{1} {C}_{OLED}}{{C}_{2} + {C}_{1} + {C}_{OLED}} {V}_{DATA}$$

This equation derives from the charge sharing between the three capacitances after the step change in voltage on the data line 6 disturbs the equilibrium. C₁ is the capacitance of the drive transistor storage capacitor 30, C₂ is the capacitance of the snap-off transistor storage capacitor 40, and C_{OLED} is the capacitance of the OLED display element.

The step change in the column voltage does not corrupt the threshold voltage measurement (assuming no leakage currents have occurred) and the data voltage has some capacitive division. However, this capacitive division will be small as C_{OLED} will generally be much larger than C₁ or C₂. Example values might be for a 300 μm×100 μm pixel at 40% aperture C_{OLED}=1.5 pF, C₁=0.1 pF and C₁=0.5 pF. In this case, the division factor is 0.76, so most of the data is stored.

The addition of data onto the capacitor 30 will also be accurate as there are only small leakage currents flowing through either T_{S} or T_{D} when the data is added, and the data acts to turn the snap-off transistor even further off (below its threshold) so current cannot flow through T_{S} at the data addition time (which is short).

### Step 4—Measure the Drive Transistor Threshold

In this step, the threshold voltage of all drive TFTs T_{D} in the display are measured at the same time. The snap-off transistor T_{S} is completely off if it is storing data for a pixel in the on-state, or nearly off if it is storing data for a pixel in the black state.

The cathode voltage is then brought lower, for example to 0V, as shown in FIG. 8. This pushes the anode sufficiently low to turn on the drive transistor T_{D}. The address lines A2 are brought high to hold the drive transistor gate voltage to 0V, and the drive transistor T_{D} discharges the capacitor 30 to the threshold of the drive TFT. As a result, a voltage of −V_{T}(T_{D}) is then present on the cathode, as shown in FIG. 8.

### Step 5—Add Constant Drive Voltage to the Capacitor 30

A fixed drive voltage is then added to all capacitances 30 in the display by moving all charge lines through, for example 5V. With reference to FIG. 8, as the charging line is moved through its voltage swing i.e. 0V to V_{CHARGE} then the result voltage upon the capacitor 30 is given by

$${V}_{1} = {V}_{T} ( {T}_{D} ) + \frac{{C}_{OLED}}{{C}_{1} + {C}_{OLED}} {V}_{CHARGE}$$

Therefore, a voltage of approximately 0.75*5V+V_{T}(T_{D}) is provided on capacitor 30 (having capacitance C₁). All of the address lines A2 are then brought low.

The accuracy of the measurement of V_{T}(T_{D}) will not be perfect for two reasons. The first is that adding the data will turn-on the drive transistor T_{D}, so that current will flow through the drive transistor T_{D} to corrupt the measurement stored on the capacitor 30. The second is that for black pixel states, the snap-off transistor T_{S} is at its threshold and will therefore tend to decay charge stored on the capacitor 40. However, a rough estimate only of the threshold voltage of the drive transistor T_{D} is required, as the optical feedback will correct any errors.

Step 6—Operate Pixel with Optical Feedback

The final step is to bring the cathode down to its operating point of −15V to illuminate all pixels in the display at the same time in the manner shown in FIG. 4. The circuit then operates as described in WO 2004/084168.

There are six steps within the frame time outlined above. The first step is a preparation stage to enable the subsequent steps to be carried out. The five subsequent steps are summarised in FIG. 9 and a more detailed timing diagram showing all of the steps is shown in FIG. 10.

The circuit requires the address lines A1 and A2 (for the address transistor 16 and the charging transistor 34) to be independent and also requires the gate of the feedback photosensitive TFT 38 to be connected to an independent common line to make sure that it does not turn on.

However, there is no need to switch the power lines of the display, as required in some of the examples in WO 2004/084168.

It is possible to remove the charge line 32 and connect the charging transistor 34 between the power line and the capacitor 30. In this case, in step 5 where the charge line voltage is changed to couple data onto the capacitor 30, the power supply line would be moved to a higher voltage to couple the data voltage to the capacitor 30.

One potential difficulty in the operation described above is during step 2 when the threshold of the snap-off transistor T_{S} is measured.

Amorphous silicon TFTs have a minimum leakage current at a negative gate-source voltage. As this minimum is not at 0V, the drive transistor is still passing current, and this corrupts the measurement of the snap-off transistor threshold voltage. With reference to FIG. 7, although transistor 30 is discharged, the leakage current in the drive transistor influences the voltage stored on the capacitor 40 when measuring the threshold voltage.

If, however, the drive TFT threshold voltage has drifted by one or two volts (as an example order of magnitude), then the snap-off transistor threshold measurement is improved, as the drive transistor is then biased to its minimum leakage current by providing a gate-source voltage of 0V.

The problem of leakage current through the drive transistor can be overcome by the addition of a dual gate to the drive transistor T_{D}, as shown in FIG. 11.

The extra gate enables the drive transistor to be turned off to stop any current flowing through the drive transistor T_{D} when both V_{T}(T_{S}) and V_{T}(T_{D}) are measured.

Accurate measurements will then be obtained for both threshold voltages.

Alternatively, a set up phase can be applied whereby the threshold voltage of the drive transistor is forced to drift by the required amount before the display is used. This can be achieved by holding the cathode at the power supply voltage, for example storing −1V on the capacitor 40 to make sure it is off and then applying at high voltage to the charge line (A2 is high) for example 20V. This voltage will be stored on the capacitor 30 by bringing address line A2 low again. This gives the drive transistor large positive gate bias and it will drift sufficiently within a few hours.

The gate line A2 will need to go above the charge line voltage but only for a short time. After a pre-determined drift time, the capacitor 30 is be discharged by bringing the snap-off transistor T_{S} on for a short time.

A further alternative is to use a slight variation of the drive scheme to enable the approximate measurement of V_{T}(T_{D}), without measuring the snap-off transistor threshold voltage. This approach may enable the lifetime of the feedback compensation scheme to be extended and is appropriate if the threshold variations of the snap-off transistor are found not to have a significant impact. This may be appropriate for an amorphous silicon implementation in which the drive transistor threshold drift significantly affects the lifetime over which the optical feedback system can function correctly. The low voltage stresses applied to the snap-off transistor mean that the threshold voltage variations are less significant and may not need to be corrected.

The steps for this case are now described briefly with reference to FIG. 12.

### Step 1—Initialisation

The cathode is brought to 0V, namely the same potential as the power line.

The address line A2 goes high and the charge line is held at a high potential e.g. 10V. This turns on the drive transistor T_{D} hard and pulls the anode up to the power line voltage (0V). This provides a good reference for adding the data voltage, and the OLED is off.

### Step 2—Pixel Data Storage

While the anode is held at this reference voltage (which holds one side of the capacitor 40), the data is added to the capacitor 40 a line at a time by addressing the appropriate A1 lines.

### Step 3—Drive Transistor Threshold Measurement

Having stored the data voltages for all lines the threshold voltage of the drive transistor is measured. All address lines A1 and A2 are low for this operation. The charge line is brought to 0V and the cathode is taken high e.g. 5V, and this is shown as step 3.

### Step 4—Coupling Fixed Drive Voltage to Storage Capacitor

The address lines A2 are then turned on and the cathode is driven back to 0V. The drive transistor then discharges to its threshold. The charge line is then pulled high to, for example, 5V to couple on data.

### Step 5—Illumination

The cathode is then pulled down to turn on the OLED elements to illuminate the display, in step 5.

For implementations using low temperature polysilicon, the threshold voltage variations in the drive transistor are less significant, and the optical feedback system can compensate for the threshold voltage variations over the full expected lifetime. In this case, only the small threshold voltage variations of the snap-off transistor T_{S} remain uncompensated. Thus a drive scheme for an LTPS implementation can correct only for the snap-off transistor threshold voltage.

An LTPS implementation of the circuit can be exactly that of FIG. 4, where the photosensitive element can either be a photoTFT (as shown) or a NIP/PIN amorphous silicon photodiode, or even a photo-resistor.

As mentioned above, the leakage current through the drive transistor can reduce the accuracy of the measurement of the snap-off transistor threshold voltage. LTPS TFTs have a minimum leakage when the gate source voltage is zero, so that the drive transistor leakage current may not corrupt significantly the measurement of the snap-off transistor threshold voltage.

However, FIG. 13 shows an LTPS circuit with an extra TFT in the current path, which enables any leakage from the drive transistor to be completely shut off whilst V_{T}(T_{S}) is measured.

FIG. 14 shows the detailed timing diagram for implementing a scheme in which only the snap-off transistor threshold voltage is compensated.

### Step 1—Initialisation

The cathode is brought high as well as all address lines A2. The first step involves providing voltage levels so that the drive transistor is operated in the opposite sense to the normal circuit operation. The purpose of this is to enable the threshold voltage of the snap-off transistor to be sampled with the OLED display element reverse biased.

### Step 2—Sample the Threshold Voltage of the Snap-Off Transistor

The address lines A1 (which in this case are for the address transistor 16 and the charging transistor 34) then go high for every display row. This has the effect of connecting the two capacitors 30,40 to fixed voltages through the charge line 32 and data lines 6. In the same way as above, the snap-off transistor threshold voltage is sampled.

The charge line does not need to be varied as no compensation of the drive transistor threshold voltage is performed.

### Step 3—Provide the Pixel Data Voltage on the Capacitor 40

The pixel data is then added to capacitor 40, each line in turn, by bringing high the relevant address line A1.

### Step 4—Illumination

As above, the cathode voltage is reduced to commence the illumination stage.

The circuits used to explain the method of the invention in detail are n-type only arrangements which are therefore suitable for amorphous silicon implementation. As shown above, the invention can also be applied to circuits for implementation using a low temperature polysilicon process, and these can use n-type and p-type devices. A common-cathode LED display element arrangement can also be used.

Other arrangements are described in WO 20041084168, and the method of the invention can be adapted to be used with these circuit modifications

Various other modifications will be apparent to those skilled in the art.

1. A method of driving an active matrix display device comprising an array of display pixels each comprising a drive transistor (22) and a current-driven light emitting display element (2), the method comprising, for each addressing of the pixel:
measuring a threshold voltage of a drive transistor (22);
adding a drive voltage to the drive transistor threshold voltage to derive a compensated drive voltage and storing this on a storage capacitor;
driving the drive transistor (22) using the compensated drive voltage;
switching on a discharge transistor (36) using charge flow through a light dependent device (38) illuminated by the light output of the display element (2) and in dependence on a pixel voltage supplied to the pixel; and
discharging the storage capacitor (30) using the discharge transistor (36) at a time dependent on the pixel voltage and the light output, thereby to turn off the drive transistor.

2. A method as claimed in claim 1, wherein the light-dependent device (38) controls the timing of the operation of the discharge transistor (36) by varying the gate voltage applied to the discharge transistor (36) in dependence on the light output of the display element (2).

3. A method as claimed in claim 1, wherein the light-dependent device (38) controls the timing of the switching of the discharge transistor (36) from an off to an on state.

4. A method as claimed in claim 1, wherein the light dependent device (38) is for charging or discharging a discharge capacitor (40) provided between the gate of the discharge transistor (36) and a constant voltage line.

5. A method as claimed in claim 1, further comprising:
measuring a threshold voltage of the discharge transistor (36); and
adding the pixel voltage to the discharge transistor threshold voltage to derive a compensated pixel voltage, the storage capacitor (30) being discharged at a time dependent on the compensated pixel voltage.

6. A method as claimed in claim 5, performed in the following order:
measuring a threshold voltage of the discharge transistor (36);
deriving the compensated pixel voltage;
measuring the threshold voltage of the drive transistor (22);
deriving the compensated drive voltage;
driving the drive transistor (22);
switching on a discharge transistor (36); and
discharging the storage capacitor (30).

7. A method as claimed in claim 5, further comprising biasing the drive transistor oppositely to the bias for driving the drive transistor (22) using the compensated drive voltage, before measuring a threshold voltage of the discharge transistor.

8. A method as claimed in claim 5, wherein measuring a threshold voltage of the discharge transistor comprises driving the discharge transistor using a capacitor connected between the gate and source until the discharge transistor turns off.

9. A method as claimed in claim 1, wherein measuring a threshold voltage of the drive transistor comprises driving the drive transistor using the storage capacitor until the drive transistor turns off.

10. A method as claimed in claim 1, wherein drive transistor comprises an amorphous silicon transistor.

11. A method of driving an active matrix display device comprising an array of display pixels each comprising a drive transistor (22) and a current-driven light emitting display element (2), the method comprising, for each addressing of the pixel:
driving a current through the drive transistor by applying a gate voltage to the drive transistor which comprises a fixed component and a component which depends on a measurement of the threshold voltage of the drive transistor (22); and
switching off the drive transistor using a discharge transistor for discharging a capacitance between the gate and source of the drive transistor, and at a time which depends on the optical output of the display element and a pixel data signal.

12. A method as claimed in claim 11, wherein the time at which the drive transistor is switched off also depends on a measured threshold voltage of the discharge transistor (36).

13. A method as claimed in claim 11, wherein the drive transistor comprises an amorphous silicon transistor.

14. A method of driving an active matrix display device comprising an array of display pixels each comprising a drive transistor (22) and a current-driven light emitting display element (2), the method comprising, for each addressing of the pixel:
driving a current through the drive transistor by applying a gate voltage to the drive transistor which comprises a fixed voltage; and
switching off the drive transistor using a discharge transistor for discharging a capacitance between the gate and source of the drive transistor, and at a time which depends on the optical output of the display element, a pixel data signal and a measured threshold voltage of the discharge transistor (36).

15. A method as claimed in claim 14, wherein the gate voltage applied to the drive transistor comprises the fixed voltage component and a component which depends on a measurement of the threshold voltage of the drive transistor (22).

16. A method as claimed in claim 14, wherein the drive transistor (22) comprises a low temperature polysilicon transistor.

17. An active matrix display device comprising an array of display pixels, each pixel comprising:
a current-driven light emitting display element (2);
a low temperature polysilicon drive transistor (22) for driving a current through the display element (2);
a storage capacitor (30) for storing a voltage to be used for addressing the drive transistor (22);
a discharge transistor (36) for discharging the storage capacitor (30) thereby to switch off the drive transistor; and
a light-dependent device (38) for controlling the timing of the operation of the discharge transistor by varying the gate voltage applied to the discharge transistor (36) in dependence on the light output of the display element (2),
wherein the device further comprises means for implementing a threshold voltage measurement of the discharge transistor (36) and wherein each pixel further comprises an isolating transistor connected between a power supply line and the drive transistor for switching off the drive transistor during a threshold voltage measurement of the discharge transistor.
